(19) United States
(12) Patent Application Publication
(10) Pub. No.: US 2007/0047748 A1
(43) Pub. Date: Mar. 1, 2007

(54) Cycle sound system

(76) Inventor: Del Rusher, Henderson, NV (US)

Correspondence Address: DEL RUSHER, 2412 Legacy Island Circle, Henderson, NV, 89074, US

(21) Appl. No.: 11/213,397

(22) Filed: Aug. 29, 2005

(51) Int. Cl. H04R 5/02

(52) U.S. Cl. 381/311

(57) ABSTRACT

A cycle sound system is disclosed that quick-connects interchangeably to cycle seats, backpacks, handbags, and shoulder bags. Left and right gripping assemblies mount quick-connectably to the handlebars and include control levers or buttons for preferably wireless connection to the sound system. The gripping assemblies preferably include speakers and can alternatively be used alone as a complete cycle sound system.

### BACKGROUND OF THE INVENTION

1. Field of the Invention

Bicycles, tricycles, and motored cycles are commonly sold without any method for the cyclist to listen to music or other audible recordings. Many people like to listen to music while riding their cycle of choice, especially during longer trips and marathon rides. To accomplish this, some sort of stereo is commonly tethered, tied, or otherwise fastened to the cycle in whatever fashion the cyclist can devise. Because stereos are often heavy and cumbersome, they tend to change the cycle's center of balance and to cause a more strenuous ride for the cyclist, who must constantly compensate for the extra load. The stereos typically have controls that are awkward to operate during cycle-riding. The stereos are also often time-consuming to connect or disconnect from the cycle when the cyclist would like to secure against the weather and against theft. The present invention relates to a cycle sound system that is convenient for the cyclist to operate, does not interfere with the cyclist's center of balance, and is quick-connectable.

2. Description of the Prior Art

As shown in U.S. Pat. Nos. 2,588,671; 3,598, 295; 4,436,350; 4,445,228 and 4,981,243; various stereo holders have also been devised that are bolted or clamped to a cycle's handlebars. Because the stereo equipment is bolted or locked to the holder, and the holder is separately bolted or clamped to the cycle, disconnecting these systems from the cycle is inconvenient and prevents the cyclist from quickly securing the audio equipment when taking a break from the ride.

U.S. Pat. Nos. 4,662,547; 4,754,901; and 4,756,454 are similarly clamped to the handlebars, and comprise an equipment carrier including speakers, to which audio equipment is quick-connected with a strap. Because the speaker system is not quick-connectable, it is not protected from weather damage or theft. Constant movement during the cycle-riding experience could lead to fraying of the straps, and to movement of the audio equipment within the holder.

U.S. Pat. No. 5,159,712 discloses a radio that is strapped to a cycle's handlebars. Similarly, U.S. Pat. No. 5,771,305 discloses a stereo holder that is strapped to a cycle's handlebars. These systems are quick-connectable, but the stability of the stereo system is likely to change over time, due to fraying and dry-rotting of the straps.

U.S. Pat. No. 6,219,428 discloses a radio tote bag that is strapped to a cycle's handlebars. An enclosed radio unit connects both to a speaker mounted near the cycle's rear support bar, and to a battery pack mounted in between the two. Because all these components are mounted to separate sections of the bike, disconnection appears to be a time-consuming process. Similarly, U.S. Pat. No. 5,222,752 discloses a front fairing assembly that includes an audio source and speakers, and that is attached to the handlebars. The front fairing assembly connects to a rear tail assembly that includes a motorcycle battery, making the entire system bulky and difficult to disconnect.

All of the aforementioned patents disclose portable stereo assemblies that are mounted to a cycle's handlebars, adding significant weight to the front end of the cycle and affecting the cyclist's center of balance. Speakers mounted to the handlebars direct all their sound to the front of the cyclist in an acoustically incorrect manner, and can become a safety hazard when ambient sounds caused by nearby cyclists, automobiles, or animals are not heard. Furthermore, stereo assemblies mounted to the handlebars are likely to obstruct the view of the cyclist at some point along the ride, and could get in the way during a crash and thereby cause injury to the cyclist.

U.S. Pat. No. 3,771,827 discloses a radio compartment bolted between two sections of a cycle seat, or to the bottom of a one-piece cycle seat. Control knobs protrude from the bottom of the compartment for control. The radio compartment is insulated to protect the radio, so it is unclear where the sound would come from. This invention relies on bolts to prevent theft, but would do little to dissuade a determined thief, or to protect the radio from natural weathering processes.

U.S. Pat. No. 5,001,779 discloses a package for a sound system that is held magnetically to the cycle, and supplementally-strapped below the handlebars. The magnetic mounting system is separated from the cycle with fabric to prevent scratches, and could dislodge during an abrupt turn or bump in the road. If the package were left swinging from the supplemental strap, it would throw off the balance of the cycle. The straps are hooked at each end to make the package quick-connectable, but normal wear and tear during the cycle-riding experience would likely lead to stretching of the straps, so that were the magnets to become uncoupled from the cycle, the package could swing back and forth even more than when the package was new. This system is designed to be located between the cyclist and the handlebars, and would tend to get in the way of the cyclist, especially during mount and dismount from the cycle.

### BRIEF SUMMARY OF THE INVENTION

The present invention comprises a quick-connectable sound system that preferably mounts to the base of the cycle seat. The sound system comprises left and right speakers to provide acoustically correct stereo audio to the left and right sides of the cyclist. The speakers are mounted to a case that also preferably houses and provides a connection source to the cyclist's music source of choice. When the inventive sound system is removed from the cycle, it can be easily carried by hand, or alternatively quick-connected to a backpack, shoulder bag or handbag so that the cyclist can listen to preferred audio programming without interruption.

The preferred embodiment of the current invention utilizes an MP3 player to provide virtually unlimited variety of music at the cyclist's fingertips, an amplifier to provide the speakers with the capability of high decibel sound, and a transponder for communicating with at least one control assembly via wireless technology. The primary control assembly comprises at least one control button or lever for selecting the decibel level the cyclist desires to hear, preferably a wireless transponder, and preferably a tweeter-type speaker. The control assembly is preferably housed within a right handgrip assembly, and is quick-connectable to the cycle. A secondary control assembly is almost identical to the primary control assembly, but the at least one control button or lever preferably selects the track the cyclist desires to hear, and is preferably mounted within a left handgrip assembly. When the cyclist is ready to take a break from cycling, the primary and secondary control assemblies are quickly disconnected from the handlebars and preferably inserted into a pocket of the sound system case.

Alternative embodiments utilize either a for radio frequency receiver including AM, FM, and/or satellite-based radio; or media players including cassette, compact disk, MP3 players, and any other storage device that may become the fad of the day.

Power is provided to the sound system and control assemblies by means of battery means and/or solar cells. The battery is preferably of the rechargeable type, enabling it to be charged by solar cells and/or by connection to a standard electrical outlet.

### DETAILED DESCRIPTION OF THE INVENTION

The preferred embodiment of the inventive sound system assembly comprises a substantially triangularly-shaped body; a primary speaker mounted to a left side of the sound system body to provide audio to the left side of the cyclist; and a secondary speaker mounted to the right side of the sound system body to provide audio to the right side of the cyclist; so that acoustically-correct stereo audio is provided to the cyclist. A primary supplemental speaker such as a tweeter is preferably also mounted to the left side of the sound system body, and a secondary supplemental speaker such as a tweeter is preferably mounted to the right side of the sound system body to further enhance the quality of sound provided to the cyclist.

The preferred sound system assembly further comprises audio amplification means mounted within the sound system body to provide static-free audio to the speakers, power means to operate the audio amplification means and speakers, audio connection means for connection of a desired audio source, and preferably quick-connect means for mounting the entire sound system assembly to a cycle seat, bag, or person.

The cyclist has the option of either quick-connecting the sound system assembly to a cycle seat prior to a cycle ride for acoustically-correct stereo audio; or quick-connecting the sound system assembly to a backpack so that acoustically-correct stereo audio is heard when the cyclist wears the backpack; or quick-connecting the sound system assembly to the cyclist's waist as a fanny pack so that acoustically-correct stereo audio is heard wherever the cyclist is. Therefore the cyclist can easily connect and disconnect the sound system as desired to provide continuous stereo audio during various activities, such as riding a cycle, hiking, or moving about a campsite, for example. When the lightweight sound system is mounted under the cycle seat, the cyclist's center of gravity is not affected. However, the quick-connect system can just as easily be mounted to other parts of the cycle the cyclist may desire; including the front stem, the top tube, the back rack, etc.

The sound system body of the preferred embodiment is made of weather-resistant or waterproof materials, and houses left and right speakers that provide acoustically-correct stereo audio to left and right sides of the cyclist. The speakers are preferably constructed of waterproof or weather resistant materials.

The audio amplification means amplifies the audio signals it receives from a preferably low-power audio source that can alternatively be used to provide audio signals to low power speakers. This makes the mobile system even more portable by allowing the cyclist to separate the audio source from the sound system assembly and listen to it via earplugs, or other low-power speakers such as those contained in a laptop or desktop computing device; or to connect the audio source to alternative amplification means such as a home theater system. The audio source of the preferred embodiment comprises an MP3 player that can be easily interchanged with any alternate format media player including a compact disc player; or alternatively, a radio-receiving device for AM, FM, and/or satellite-based signals. The various choices of audio source can either be supplied with the sound system, or the cyclist can choose to connect an audio source already in possession.

In the preferred embodiment, the audio amplification means is controlled via at least one remote control device that is preferably mounted to the handlebar and preferably comprises a replacement for the typical handlebar grip. The primary remote control device of the preferred embodiment comprises a right gripping means and control lever. The control lever is movable in multiple directions to control the decibel level produced by the speakers. Therefore, the cyclist can easily turn up the volume by moving the lever closer, turn down the volume by moving the lever away, or temporarily mute the volume by moving the lever sideways. An optional left remote control device similarly comprises a control lever that is movable in multiple directions to control the audio track being played by the audio source. Therefore, the cyclist can easily repeat the track or move backward through the tracks by moving the lever closer, select the next track or go forward through the tracks by moving the lever away, and stop or temporarily pause the track by moving the lever sideways. The remote control devices can be connected to the sound system body via a wire harness, but preferably communicate via wireless transponders, and further comprise integral power means including solar and/or battery means.

Another embodiment uses control buttons embedded within a right gripping means to control the decibel level produced by the speakers. Therefore, the cyclist can easily turn up the volume by pressing a primary right control button, turn down the volume by pressing a secondary right control button, or temporarily mute the volume by pressing a tertiary right control button. Similarly, control buttons are embedded within a left gripping means to control the audio track being played by the audio source. Therefore, the cyclist can easily repeat the track or move backward through the tracks by pressing on a primary left control button, select the next track or go forward through the tracks by pressing a secondary left control button, and stop or temporarily pause the track by pressing on a tertiary left control button. These are way of example only and many other button functions could easily be used without changing the nature of the invention.

The preferred embodiment is capable of achieving true surround sound for superior audio quality, because the remote control devices preferably each house an audio speaker, such as a tweeter, to supplement the audio produced by the primary and secondary speakers. It is also possible to use the remote control devices separately from the sound system body, by connecting a miniature MP3 player or similar next to the gripping assembly of the remote control device.

In yet another embodiment, the audio amplification means can be controlled via a primary turn knob connected to a primary rheostat that adjusts volume, and preferably a secondary turn knob connected to secondary rheostat that selects the track being played.

The sound system assembly components are each powered by at least one battery or solar cell. The preferred embodiment comprises a bank of solar cells for operation during daylight. To help ensure consistent operation in a variety of environments, including cloudy conditions and shade from buildings or landscaping, at least one solar cell preferably delivers a charge to at least one rechargeable battery until a sufficient charge is achieved to power the sound system. This is easily achieved by a circuit that starts passing electric current when the voltage supplied by the battery reaches a desired peak voltage, and stops passing electric current when the battery voltage falls below the desired operating range. Should a user desire to operate the sound system prior to the battery becoming fully charged via the at least one solar cell, quicker battery-charging is achieved via connection to a standard electrical outlet, and indication means including a visible and/or an audible signal indicates to the user that peak voltage has been achieved. The indication means preferably consists of a blinking green LED light, and/or an intermittent audible chirp.

Another embodiment utilizes solely battery power, and is preferably equipped with a built-in battery charger so that the cyclist can simply plug the sound system into an electrical outlet when finished listening for a while.

References herein to the details of the invention are by way of example only and are not intended to limit the scope of the claims which themselves recite those details regarded as important to the invention.

1. A sound system comprising:
a) a sound system housing;
b) at least one audio speaker mounted to the sound system housing;
c) an audio source located within the sound system housing and connected to the audio speaker;
d) power means; and
e) quick-connect hardware means for mounting the sound system housing within proximity of the listener.

2. The sound system of claim 1, wherein:
a) the top and bottom of the sound system housing is constructed of a substantially triangular shape;
b) at least one audio speaker is mounted to the left vertical wall of the sound system housing; and
c) at least one audio speaker is mounted to the right vertical wall of the sound system housing;
wherein the left and right speakers provide audio to the left and right sides of the listener.

3. The sound system of claim 1 further comprising a cycle, wherein the sound system housing is quick-connectable to the base of the cycle seat.

4. The sound system of claim 1, further comprising a backpack; wherein the sound system housing is quick-connectable to the top or bottom of the backpack.

5. The sound system of claim 1, wherein the sound system housing is quick-connectable to the waist of the listener.

6. The sound system of claim 1, wherein the sound system housing is interchangeably quick-connectable to a cycle seat, front stem of a cycle, top tube of a cycle, back rack of a cycle, a backpack, or to a belt or other garment worn about the waist of the listener where the sound system is worn like a fanny pack.

7. A sound system comprising:
a) a sound system housing;
b) at least one audio speaker mounted to the sound system housing;
c) an audio source located within the sound system housing and connected to the audio speaker;
d) power means; and
e) quick-connect hardware means for mounting the sound system housing to a cycle.

8. The sound system of claim 7, further comprising at least one remote control assembly for mounting to the handlebars within easy reach of the cyclist.

9. The sound system of claim 8, wherein at least one remote control assembly further comprises a handgrip that the cyclist grips while cycling, whereby the controls are conveniently accessible during cycling.

10. The sound system of claim 8, wherein at least one control comprises a finger or thumb-actuated lever.

11. The sound system of claim 8, wherein at least one control comprises a finger or thumb-depressible button.

12. The sound system of claim 8, wherein at least one control comprises a finger or thumb-actuated lever.

13. The sound system of claim 8, further comprising a transponder for wireless communication located within the sound system housing, and a transponder also located within the remote control assembly.

14. The sound system of claim 8, further comprising at least one speaker mounted within the remote control assembly.

15. The sound system of claim 14, further comprising connection means for attaching an audio source directly to the remote control assembly, for operation when communication with the sound system housing is not necessary, such as when low volume audio is desired.

16. A sound system comprising:
a) a sound system housing, wherein at least a portion of the sound system housing is shaped into a handgrip for the cyclist to use while cycling;
b) at least one audio speaker mounted to the sound system housing;
c) an audio source located within the sound system housing and connected to the audio speaker; and
d) power means;
wherein the sound system replaces at least one standard factory handgrip.

17. The sound system of claim 16, further comprising finger actuated control means for adjusting the volume, and/or cycling through the tracks or channels being listened to.

18. The sound system of claim 16, further comprising quick-connect hardware means for removably mounting the sound system to at least one handlebar of a cycle.

19. The sound system of claim 16 wherein the sound system housing is attached to a cycle's right handlebar, further comprising a secondary and substantially identical sound system housing attached to the cycle's left handlebar, whereby the right sound system provides audio to the right side of the cyclist and the left sound system provides audio to the left side of the cyclist.

20. The sound system of claim 19, wherein the audio source is located within a primary sound system housing, and the power source is located within a secondary sound system housing, and further comprising a wire harness for audio and power communication between the left and right sound system housings.
